(19) United States
(12) Patent Application Publication
(10) Pub. No.: US 2019/0064211 A1
(43) Pub. Date: Feb. 28, 2019

(54) SCANNING PROBE MICROSCOPE

(71) Applicant: Oxford Instruments Asylum Research, Inc., Santa Barbara, CA (US)

(72) Inventors: David A. Grigg, Goleta, CA (US); Deron Walters, Santa Barbara, CA (US); Haigang Zhang, Goleta, CA (US); Jason Cleveland, Ventura, CA (US)

(21) Appl. No.: 15/692,231

(22) Filed: Aug. 31, 2017

(51) Int. Cl. G01Q 70/06; G01Q 70/08; G01Q 10/04; G01Q 20/04

(52) U.S. Cl. CPC G01Q 70/06; G01Q 70/08; G01Q 90/00; G01Q 20/04; G01Q 10/04

(57) ABSTRACT

A scanning probe microscope has a probe configured to move across the surface of a sample to be monitored. A scanner, to which the probe is mounted, moves the probe across the sample surface such that the probe is deflected in accordance with the structure of the sample surface. A beam system directs a light beam at the probe during the movement of the probe across the sample surface and a detector monitors the deflection of the probe using the light beam. The arrangement is such that the scanner is physically independent of the beam system.

### FIELD OF THE INVENTION

The present invention relates directly to the field of scanning probe microscopes (SPMs) and more particularly relates to a tip scanning SPM in conjunction with a deflection beam probe sensing technique.

### BACKGROUND OF THE INVENTION

Scanning probe microscopes (SPMs) can be used for a wide range of applications to measure materials with molecular or even atomic level resolution. The range of applications can often drive the need for the instrument to accommodate a wide range of sample and experimental conditions such as; large sample size, multiple sample or multiple site measurements on a sample, or maintaining the sample in a variety of environments or conditions.

The term SPM refers to a more general group of instruments where the three most common types are; Atomic Force Microscopes (AFM), Scanning Tunnelling Microscopes (STM), and Near-Field Scanning Optical Microscopes (NSOM). Traditional SPMs, particularly atomic force microscopes (AFMs), are of the type that moves the sample relative to the probe when measuring a sample. This arrangement is commonly referred to as a “sample scanning SPM”. Early examples of this type are described in U.S. Pat. No. 4,935,634 to Hansma et al. and U.S. Pat. No. 5,025,658 to Elings et al and more recently in U.S. Pat. No. 8,370,960 to Proksch et al and U.S. Pat. No. 9,097,737 to Viani et al. Measurement scan sizes for most SPMs are typically <100 μm. However, as many applications require large samples to be measured or that multiple locations or multiple samples are to be measured that are much further apart than the scan size, it becomes impractical to scan the sample while maintaining or improving performance requirements such as scan speed, noise and stability. To accommodate these demands a second class, or type, of SPM can be utilized in which the probe is moved relative to a stationary sample. This arrangement is commonly referred to as a “tip scanning SPM”. For a tip scanning SPM, the size and mass of the object being moved to generate the SPM measurement, namely the probe, is kept small relative to the sample and permits more freedom in the manner in which the samples are mounted or maintained within required conditions during measurement. An early example of a tip scanning AFM is described in U.S. Pat. No. 5,144,833 to Amer et al and Baselt et al., “Scanned-cantilever atomic force microscope”, Rev. Sci. Instrum. Vol 64, No. 4, pp. 908-911, 1993. However, the scan size in this early adoption was severely restricted so as to maintain the beam deflection laser spot on the back of the probe.

The simplest form of a tip scanning SPM for larger scan sizes is for the whole optical detecting system to move along with the probe. However, the optical detecting module, which includes the laser source, position sensitive detector, the alignment mechanisms and the supporting structure can result in an undesirable amount of mass and complexity attached to the scanner, particularly on the Z axis mechanism. This puts severe limits on the speed and stability of the overall design. Many solutions take this approach and simply try to keep the overall size, mass and complexity as low as possible. An example is described U.S. Pat. No. US2005/0061970 A1 to Knebel et al.

Others have designed of SPMs that move only the probe in Z and the sample is moved in X and Y. These SPMs are further referred to as “hybrid scanning SPMs”. By only moving the probe in Z, this avoids having to track the probe in the larger X and Y direction scanning motions, but it is still necessary to address the false deflection errors from motion of the probe in Z. Such examples are from Kwon e al., “Atomic force microscope with improved scan accuracy, scan speed and optical vision”, Rev Sci. Instrum., Vol. 74, No. 10, pp. 4378-4383, 2003; U.S. Pat. No. 6,677,567 to Hong et al, and more recent in U.S. Pat No. 20070220958 to Gotthard et al, a laser tracking mechanism that is decoupled from the scanner is described. In the case of Gotthard et al, the implementation teaches little for how this would be used for X and Y direction tracking use and in practice still resulted in large deflection errors in the Z direction.

### SUMMARY OF THE INVENTION

In accordance with the invention we provide a scanning probe microscope, comprising:

a probe configured to move across the surface of a sample to be monitored;
a scanner, to which the probe is mounted, configured to cause said movement of the probe across the sample surface such that the probe is deflected in accordance with the structure of the sample surface;
a beam system for directing a light beam at the probe during said movement of the probe across the sample surface; and
a detector for monitoring the deflection of the probe using the light beam;
wherein the scanner is physically independent of the beam system.

According to the present invention, a beam system is used to manipulate the location of measurement of a probe by a detector for the purpose of following the probe as it is scanned in a scanning probe configuration. Furthermore, the optical system in the form of the beam system for this invention is designed such that the entirety of the AFM probe deflection detection system or its parts, including any final lenses or objective for focusing the beam onto the probe, are not required to be attached to or carried by the scanner or probe. This greatly reduces the interdependence between the measurement system and the scanner system and allows them to be modular.

The light beam is typically directed at the probe by one of more optical elements and none of the optical elements which direct the light beam so as to be incident upon the probe are mounted to the scanner or the probe. Thus each of the said optical elements is physically mounted to the beam system rather than the probe or scanner. The light beam typically only interacts with the probe by simple reflection from a part of the probe which is or acts as a mirror. The scanner to which the probe is mounted may therefore be configured mechanically to move entirely independently of the beam system. As such the beam system is decoupled physically and completely from the probe or scanner which maximises the benefits from the design, particularly in terms of performance benefits resulting from weight reduction.

As has been noted, the sample may be extensive in terms of its dimensions and the sample may accordingly be held in a sample holder which is moveable independently of each of the scanner, the probe and the beam system.

In most cases the surface of the sample is arranged in use to lie substantially within an X-Y plane and the scanner is configured to move the probe parallel to the X-Y plane. It will be understood that the scanner also may be provided with a Z axis movement capability which may be used in combination with the X or Y axis movements as required.

The beam system is typically configured to deflect the light beam during the movement of the probe across the sample surface so as to maintain the incidence of the beam upon part of the probe, whereby the light beam follows the probe. The beam system is therefore used to ensure that the light beam remains targeted upon a particular part of the probe as the probe is deflected during its traversal of the sample surface.

According to an embodiment the beam system comprises an objective used for directing the said beam onto said probe, wherein the objective has a principal optical axis and wherein the beam system is configured such that the angle between the principal optical axis and the part of the light beam between the objective and the probe is substantially independent of the relative position of the probe in a plane normal to the principal optical axis, with respect to the beam system. This enables the scanning movement of the probe relative to the beam system to be cancelled out optically. For example in an embodiment, the light beam incident upon the probe from the beam system is reflected from the probe and returns to the beam system, wherein the relative arrangement between the beam system and the probe is telecentric such that the angle between the part of the reflected light beam that exits the objective and the principal optical axis is dependent upon the movement of the probe in the plane normal to principal optical axis and wherein the position of the part of the reflected light beam that exits the objective with respect to the principal optical axis is dependent upon the angle of the probe in the plane normal to principal optical axis, such that there is a separation of the angular and positional components of the probe in the reflected beam.

In an embodiment which enables the movement of the probe to be cancelled by the optics of the beam system in a “dual pass” arrangement, the beam system comprises a light source, a first beam separator, a lens system, a beam steering device and a second beam separator and wherein the light source emits the light beam which is directed in a first direction by the first beam separator, through the lens system to the beam steering device, wherein the beam steering device controls the direction of the light beam and directs the light beam back, in a second direction, opposite to the first direction, through the lens system, through the first beam separator and through the second beam separator to the objective, wherein the light passes through the objective in the second direction and is incident upon the probe, wherein the light beam is reflected from the probe back through the objective in the first direction and passes through the second beam separator, through the first beam separator and then the lens system again to the beam steering device, wherein the light beam is again directed by the beam steering device back, in the second direction, through the lens system, to the first beam separator and is directed to the detector.

In another embodiment which is a “single pass” arrangement the beam system comprises a light source, a first beam separator, a lens system, a beam steering device, a second beam separator, an objective and a focusing lens system and wherein the light source emits the light beam which is directed in a first direction by the first beam separator, through the lens system to the beam steering device, wherein the beam steering device controls the direction of the light beam and directs the light beam back, in a second direction, opposite to the first direction, through the lens system, through the first beam separator and through the second beam separator to the objective, wherein the light passes through the objective in the second direction and is incident upon the probe, wherein the light beam is reflected from the probe back through the objective in the first direction and passes through the second beam separator, to the first beam separator and then through the focusing lens system to the detector. However in this embodiment the movement of the probe is not automatically removed by the optics and instead this effect is achievable using the additional focusing lens system. In such cases the beam system is advantageously configured to project the back focal plane of the objective on to the detector.

In the two preceding embodiments the arrangement is such that the angle between the incident and reflected beams at the beam steering device is able to be relatively small. The optical arrangement may be further simplified using a larger angle at the beam focusing device. In such an embodiment the beam system comprises a light source, a second lens system, a beam steering device, a first lens system, a second beam separator and an objective and wherein the light source emits the light beam which is directed through the second lens system to the beam steering device, wherein the beam steering device controls the direction of the light beam and directs the light beam through the first lens system in a second direction, through the second beam separator to the objective, wherein the light passes through the objective in the second direction and is incident upon the probe, wherein the light beam is reflected from the probe back through the objective in a first direction, opposite to the second direction, and passes through the second beam separator, through the first lens system, to the beam steering device, wherein the beam steering device directs the light beam through the second lens system to the detector.

In another embodiment the beam steering device is used only to steer the beam which is incident upon the probe rather than the reflected beam. Here the beam system comprises a light source, a second lens system, a beam steering device, a first lens system, a second beam separator, an objective, a pick-off mirror and a third lens system and wherein the light source emits the light beam which is directed through the second lens system to the beam steering device, wherein the beam steering device controls the direction of the light beam and directs the light beam through the first lens system in a second direction, through the second beam separator to the objective, wherein the light passes through the objective in the second direction and is incident upon the probe, wherein the light beam is reflected from the probe back through the objective in a first direction, opposite to the second direction, and passes through the second beam separator, is reflected off the pick-off mirror and passes through the third lens system to the detector.

Where an objective is used to deliver the light beam to and from the probe, the objective may be used together with a beam separator to provide a top view image of the sample. This allows a device such as a camera to image the sample.

A number of different beam separator devices are envisaged for use with the invention. For example one or more of the first or second beam separators may take the form of a polarizing beam splitter and quarter wave plate in combination, or a non-polarizing beam splitter, or an optical filter or spatially separated mirrors. Likewise a number of different devices may be used as the beam steering device. These include Micro Electro Mechanical System mirror devices, goniometers or acousto-optic modulators. The detector is typically a position sensitive detector, for example a Linear 2-axis Position Sensitive Detector (PSD) or a Split Cell 4-Quadrant PSD.

With the physical independence of the beam system and the probe a convenient method is needed to ensure that the beam system provides the light beam to the probe during the monitoring of the sample. This may be achieved using a control system configured to receive position signals relating to the position of the probe and provide control signals to the beam system, in response to the position signals, in order to direct the light beam on to the probe.

The position signals may be provided by the scanner or even by software monitoring of an image of the light beam, or a separate tracking beam, incident upon the probe. The beam system may comprises a tracking system in which a tracking light beam is used to track the movement of the probe using a position sensitive detector and wherein the control system monitors the movement of the tracking light beam using the position sensitive detector and provides corresponding control signals to the beam system so as to deflect the light beam to track the probe. The beam system may therefore be operated according to the control system throughout the scanning of the sample to ensure that the light beam remains correctly positioned upon the probe so as to enable the deflection of the probe to be monitored.

The position sensitive detector used by the tracking system may be mounted to the probe or the scanner. Whilst this may simplify the number of system components it may add unwanted weight to the probe or scanner. In an alternative arrangement the position sensitive detector is remote from the scanner and probe and the tracking light beam follows a path through the beam system which is generally parallel to that of the light beam used for monitoring the deflection of the probe. Thus the optics of the beam system may be used to conveniently provide the tracking light beam to and from the probe in addition to the light beam used for monitoring the probe deflection. The tracking system may comprise a tracking light source, a tracking beam separator and a tracking lens system and wherein the tracking light source emits the tracking light beam which is incident upon the tracking beam separator and then the tracking lens, and then enters the beam system via the first beam separator, travels to and from the probe using the beam system, is received from the first beam separator, passes through the tracking lens system and tracking beam separator and is received at the position sensitive detector. A reflective target, such as a retro-reflector, may be mounted on or near the scanned probe to reflect the tracking light beam.

In order to ensure accurate tracking of the probe by the beam system the control system may be configured to monitor the position of the probe at a rate which is sufficient to modify the beam steering device to follow said probe when the probe is being moved by said scanner.

The tracking system and control system provides a means for close loop control between the probe location and the beam system.

These and other features, configurations and advantages for the invention will be apparent to those skilled in the art. The detailed description and specific examples, while being preferred embodiments of the present invention, are given as illustrations and not of limitation. Many changes and modifications may be made within the scope of the present invention without departing from the spirit of the invention and the invention includes all such modifications.

### BRIEF DESCRIPTIONS OF DRAWINGS

Some embodiments of the invention are now described with reference to the accompanying drawings, in which:

FIG. 1 is a block diagram of elements and beam paths of the AFM deflection detection system of a first embodiment.

FIG. 2 is a block diagram showing beam paths taken according to the first embodiment as the probe moves relative to the sample.

FIG. 3A to 3D is a schematic diagram illustrating the separation of angle and offset of the reflected beam from the probe at the back focal plane of the objective for the first embodiment.

FIG. 4 is a general block diagram of the main components of the embodiments.

FIG. 5 is a schematic diagram of a second embodiment of the present invention, referred to as the 0-degree single-pass configuration.

FIG. 6 is a schematic diagram of a third embodiment of the present invention, referred to as the 45-degree dual-pass configuration.

FIG. 7 is a schematic diagram of a fourth embodiment of the present invention, referred to as the 45-degree single-pass configuration.

FIG. 8 is a block diagram of the open-loop compensator used for tracking correction.

FIG. 9 is a block diagram of the closed-loop compensator used for tracking feedback.

FIG. 10 is a flow diagram illustrating the operation of a tracking feedback loop.

FIG. 11 is a schematic diagram of a laser tracking system useable with the embodiments showing how an error signal occurs when the tracking target is displaced.

FIG. 12 is a schematic diagram of the laser tracking system for one configuration of the current invention having a corrected angle θ on the beam steering device resulting in an error signal at the beam steering sensor, b, of zero.

FIG. 13 is a schematic diagram showing the combination of the beam steering mechanism to scan the beam to follow the probe and a laser tracking system.

### DESCRIPTION OF THE PREFERRED EMBODIMENTS

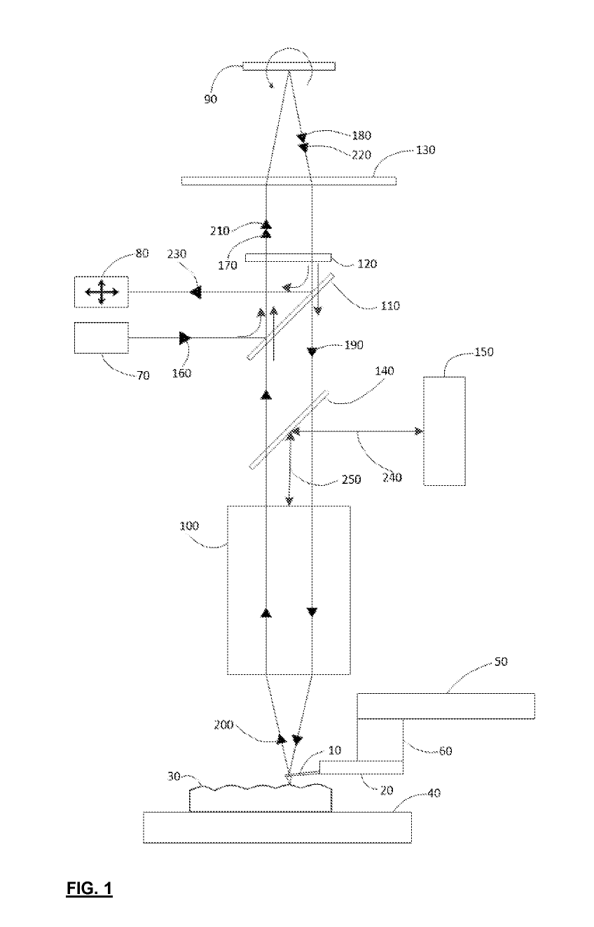

FIG. 1 shows an overall diagram of a first embodiment of the present invention. The Probe 10 is attached to and carried by a Probe Holder 20. To perform measurements and move Probe 10 relative to the Sample 30, the Probe 10 and Probe Holder 20 are scanned relative to the Sample 30 in one or more orthogonal directions, namely in the X and Y directions that are parallel to the plane of the Sample 30 surface by the XY Scanner 50 and in the Z direction that is normal to the Sample 30 surface by the Z Scanner 60. The XY Scanner 50 moves the probe in the X and Y directions and the Z Scanner 60 moves the probe in the Z direction. The Sample 30 is supported by a Sample Support Structure 40, a form of sample holder, which may consist of a means to move the sample over larger distances than otherwise provided by the XY Scanner 50 and the Z Scanner 60 for the purposes of performing measurements at different locations on the Sample 30. Neither item 70 thru 150 discussed below are carried by the XY Scanner 50 or the Z Scanner 60.

The Light Source 70 generates a light beam 160. A Polarizing Beam Splitter 110 reflects the P-polarization component of beam 160 and directs it towards a Quarter Wave Plate 120 in a first direction (upwards in FIG. 1). Upon exiting the Quarter Wave Plate 120 the polarization of beam 170 is now circular due to the Quarter Wave Plate 120. The present invention could be configured using other beam separation means such that the Beam Splitter 110 could be a variety of beam separation types such as non-polarizing beam splitter, polarizing beam splitter, optical filter or spatially separated mirrors. The preferred embodiment uses a polarizing beam splitter in conjunction with a Quarter Wave Plate 120 to improve the efficiency of the system, but could be similarly accomplished using other beam separating techniques.

Beam 170 proceeds to a Lens System 130. The Lens System 130 in the current embodiment is configured as what is commonly referred to as a telescope configuration but could similarly be a single lens or multiple lenses. The Lens System 130 directs and focuses beam 170 onto a Beam Steering Device 90. The Beam Steering Device 90 in the preferred embodiment is a 2-axis Micro-Electro-Mechanical System (MEMS) tip/tilt mirror device that is used to steer the reflected beam 180 but the functionality could be similarly realized with the use of other beam steering techniques such as Goniometers, Acousto-Optic Modulators (AOM), or other means to steer a beam of light at sufficient amplitude and frequency to be used to follow the Probe 10. After reflection from the Beam Steering Device 90, the reflected beam 180 goes through the Lens System 130 once more and then passes again through the Quarter Wave Plate 120 to change the polarization of the beam a second time. After going through the Quarter Wave Plate 120 a second time, the circular polarized beam 170 now becomes linear again but in the S-polarization direction that is 90 degrees from the original P-polarization state of beam 160. The S-polarization state allows the beam to pass through the Polarizing Beam Splitter 110 as beam 190. The beam 190 continues in a second direction opposite to the first (and so downwards in FIG. 1) to pass through the Top View Beam Splitter 140 and into the Objective 100.

The Top View Beam Splitter 140 provides a means to integrate a Top View Camera System 150 to the current invention. The Top View Beam Splitter 140 is a dichroic in the preferred embodiment but could also be a variety of non-polarizing beam splitter, polarizing beam splitter, optical filter or spatially separated mirrors. The Objective 100 focuses the beam 190 onto a reflective part of the Probe 10. The reflected beam 200 results after beam 190 reflects from Probe 10. The reflected beam 200 is collected by the Objective 100 and passes back, in the first direction (upwards in FIG. 1), through the Top View Beam Splitter 140 and the Beam Splitter 110 since the polarization of beam 200 remains the same as before so as to pass through the Polarizing Beam Splitter 110. After beam 200 passes back through the Beam Splitter 110 the polarization of the beam is rotated again by the Quarter Wave Plate 120.

Beam 210 is shown retracing the path of the first pass beam 170 in FIG. 1. Because the beam returns a second time to the Beam Steering Device 90, this configuration is referred to as a “dual-pass” configuration and because the Beam Steering Device 90 is nominally orthogonal to the system it is also referred to as a “0-degree” configuration. The first pass of the “dual-pass” scans the beam to substantially follow the Probe 10 and the second pass “de-scans” the reflected beam 200 to remove the scanning component from the reflected signal by the point at which it arrives at the Position Sensitive Detector (PSD) 80. Beam 210 is redirected and focused through the Lens System 130, as before, and is again reflected from the Beam Steering Device 90 as beam 220. Beam 220 again passes through Lens System 130 and is rotated a final time when passing through the Quarter Wave Plate 120. Finally the beam polarization has been rotated back to the same direction of the original beam 160 and reflects from the Beam Splitter 110 rather than passing through the Beam Splitter 110, as beam 230.

Beam 230 is collected by the Position Sensitive Detector (PSD) 80 to measure position changes in beam 230. The positional change of beam 230, as measured by the PSD 80, is directly related to the angular change of beam 200 reflecting from the Probe 10 and is commonly referred to as the laser deflection or optical lever detection method for AFM.

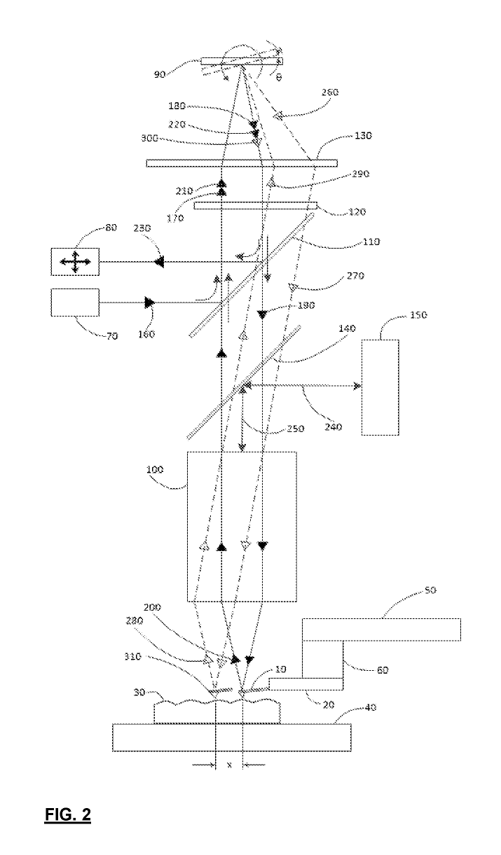

FIG. 2 shows a diagram of how changing the angle of the Beam Steering Device 90 by an angle θ results in tracking the Probe 10 as it is moved by the XY Scanner 5 by an amount “x” relative to the Sample 30 to a new location shown as Probe 310. This diagram is the same embodiment as of FIG. 1. The dashed lines and hollow arrows in FIG. 2 show the resulting beam paths when applying a new angle θ for the Beam Steering Device 90. The new angle θ of the Beam Steering Device 90 results in beam 170 reflecting from the Beam Steering Device 90 along beam path 260 instead of beam 180 in FIG. 1. After reflection from the Beam Steering Device 90, the reflected beam 260 is redirected through the Lens System 130 and proceeds to pass through the Quarter Wave Plate 120 and Polarizing Beam Splitter 110 as beam 270. The beam 270 continues to pass through the Top View Beam Splitter 140 and into the Objective 100. The Objective 100 as before focuses the beam 270 onto the new position of the Probe 310. The reflected beam 280 results after beam 270 reflects from probe 10 at the new location Probe 310.

A characteristic of this embodiment is that the angle of the beam incident to the probe remains substantially unchanged regardless of the position “x” as the Probe 10 is moved relative to the Sample 30 and the Objective 100. This condition is commonly referred to as “telecentric”. After reflection, beam 280 is collected by the Objective 100 and passes back through the Top View Beam Splitter 140 and the Polarizing Beam Splitter 110. As a result beam 290 now follows a different path than that of the first pass beam 170. Beam 290 is redirected through the Lens System 130, as before, and is again reflected from the Beam Steering Device 90 as beam 300. Note that now beam 300 retraces the same path of beam 220 generated when the Probe 10 was at the original “x” position and the Beam Steering Device 90 was at the original angle. For the same reasons as described above, after beam 300 passes through the Lens System 130 and the Quarter Wave Plate 120, the beam will have the same polarization as the original beam 160 and will reflect from the Quarter Wave Plate as beam 230, as before. In this manner, beam 230 that is collected by the Position Sensitive Detector (PSD) 80 does not substantially change position as the Scanner 50 moves the probe from Probe 10 to Probe 310 when followed with the Beam Steering Device 90.

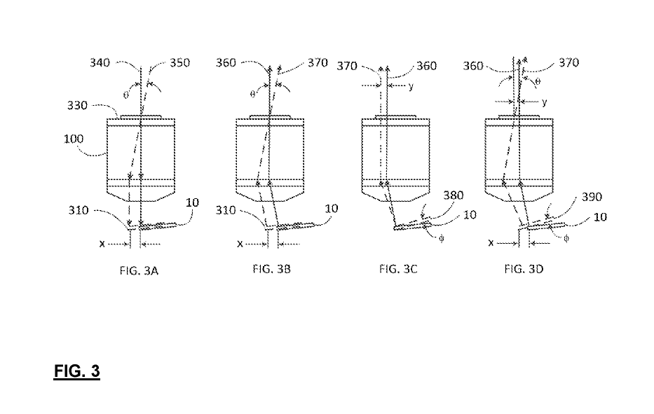

FIG. 3A shows how the beam 340 is focused onto the Probe 10 through the Objective 100. When beam 340 is tilted to the position indicated by beam 350 by a rotation of angle of θ about a point on the Back Focal Plane (BFP) 330 of the Objective 100, the resulting beam at the probe translates in a direction to follow the Probe 310 to a new location x distance from Probe 10. Note that the incident angle at the probe of both beam 340 and 350 remain parallel to each other as the probe translates from position 10 to 310. This condition is commonly referred to as telecentric and ensures that the beams remain parallel at the probe at any location in X and Y. FIG. 3B shows the reflected beams from the probe described in FIG. 3A. The reflected beams 360 and 370 rotate about a point on the Back Focal Plane 330 of the Objective 100 at an angle of θ. FIG. 3C shows the same reflected beam 370 from a probe 380 that has been deflected at an angle φ but has not been translated. In the case of FIG. 3C the reflected beam 370 changes offset position at the Back Focal Plane 330 of Objective 100. FIG. 3B and FIG. 3C show how measuring the position of the reflected beam at the Back Focal Plane 330 of the Objective 100 is used to separate the effects of scanning versus angular probe deflection in the current embodiment.

It is impractical to place a Position Sensitive Detector at the Back Focal Plane 330 of the Objective 100, therefore the Lens System 130, described above is designed to project the Back Focal Plane 330 of the Objective 100 to the Position Sensitive Detector 80. FIG. 3D shows the reflected beam 370 when the Probe 390 has been both translated by x and deflected at an angle φ. Again, FIG. 3D shows the combination of offset y and angle θ at the Back Focal Plane 330 of the Objective 100.

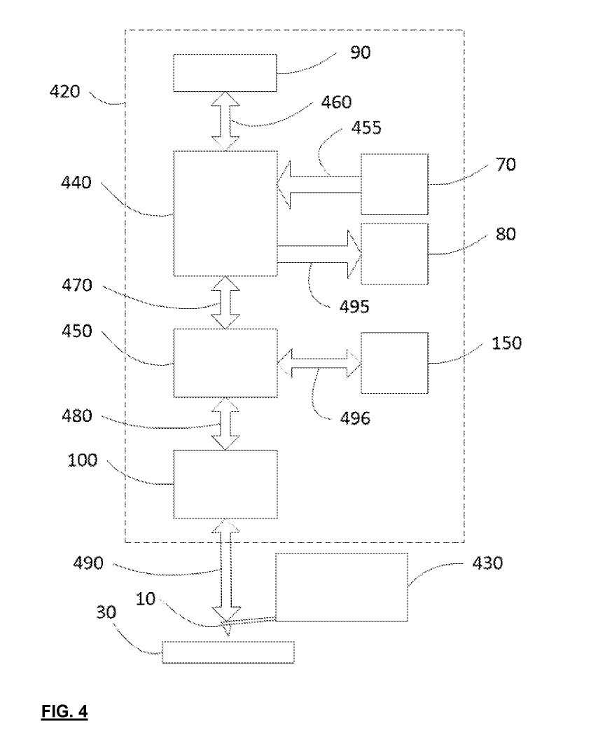

FIG. 4 is a general block diagram of the probe deflection detection system of the current invention and provides a more general description of the apparatus used in the embodiments. As before, Probe 10 is moved relative to the Sample 30 in one or more orthogonal directions by a Scanner 430. The Scanning AFM Probe Deflection Detection System (beam system) is described as the items contained within 420 and is characterized in that none of the items are carried or moved by the Scanner 430. Within the AFM Probe Deflection Detection System 420 a Light Source 70, which is commonly a laser, but could be other sources of light, is directed into a Beam Separating Device 440. The Beam Separating Device 440 introduces the light from the Source 70 into the AFM Probe Deflection Detection System 420 and directs the beam 460 to the Beam Steering Device 90. The Beam Separating Device 440 could be configured as a non-polarizing beam splitter (NPBS), polarizing beam splitter (PBS), optical filter or mirrors used to spatially separate beams and change path direction. The Beam Steering Device 90 manipulates the beam 460 to move the angle or position of the beam 460 as it returns to the Beam Separating Device 440. The Beam Separating Device 440 directs the manipulated beam 460 from the Beam Steering Device 90 to pass through the Beam Separating Device as beam 470. Again, the Beam Separating Device 440 could be configured as a non-polarizing beam splitter (NPBS), polarizing beam splitter (PBS), optical filter or spatially separating mirrors. Beam 470 proceeds to another Beam Separating Device 450 which is primarily used for the introduction of the Top View Image beam paths from the Top View Camera System 150.

Generally speaking, the Beam Separating Device 450 and the Top View Camera System 150 are an optional part of the AFM Probe Deflection Detection System, but are included as part of the embodiments discussed. As with the Beam Separating Device 440, the Beam Separating Device 450 could be configured as a non-polarizing beam splitter (NPBS), polarizing beam splitter (PBS), optical filter or spatially separating mirrors. Both beam 496 and 470 are combined in the Beam Separating Device 450 and directed to the Objective 100 as beam 480. The Objective 100 directs and focuses the AFM Probe Deflection Detection beam 490 onto the Probe 10 as well as focusing the Top View imaging towards the Sample 30 and Probe 10 so that the user has a top view perspective while operating the apparatus according to the embodiments. The reflected beam 490 is recollected by the Objective 100, passes through the Beam Separating Device 450 and into the Beam Separating Device 440. The Beam Separating Device 440 redirects beam 495 towards a Position Sensitive Detector 80 for the general purposes of measuring the AFM probe deflection motion.

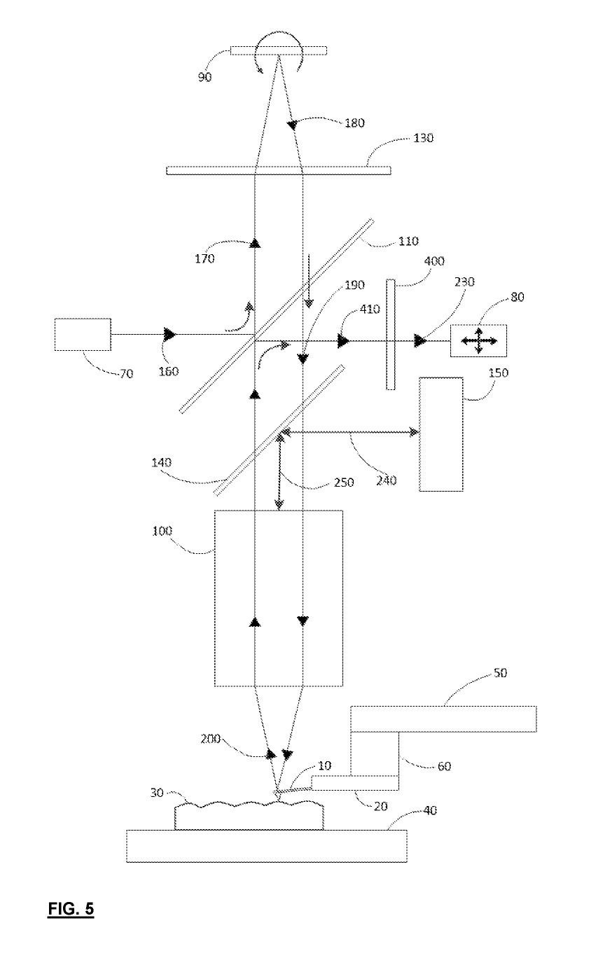

FIG. 5 shows a second embodiment where the Beam Steering Device 90 is reflected upon only one time as the beams travel from the Light Source 70 to the PSD 80. This configuration is referred to as a “single-pass” configuration. In this “single-pass” configuration, the PSD 80 is located on the opposite side of the Beam Splitter 110 from the Light Source 70. As in FIG. 1 and FIG. 2, the path taken from the Light Source 70 to the Probe 10 is generally the same, however upon reflection from the Probe 10 beam 200 is again collected by the Objective 100. It passes through the Top View Beam Splitter 140 however then reflects from the Beam Splitter 110 to follow path 410 towards the PSD 80. Because the reflected beam 200 is not “de-scanned” by returning through the Beam Steering Device 90 a second time, it is advantageous to add Focus Lens 400 that projects the Back Focal Plane (BFP) of the Objective 100 onto the PSD 80. The PSD 80 is optically located to remain sensitive to the positional component of the reflected beam 19 at the BFP of the Objective 10 but insensitive to the effects of scanning. The primary difference in this configuration, to that described in FIG. 1 and FIG. 2, is that the design of the Focus Lens 400 and the position of the PSD 80 is critical to substantially reduce virtual deflection errors.

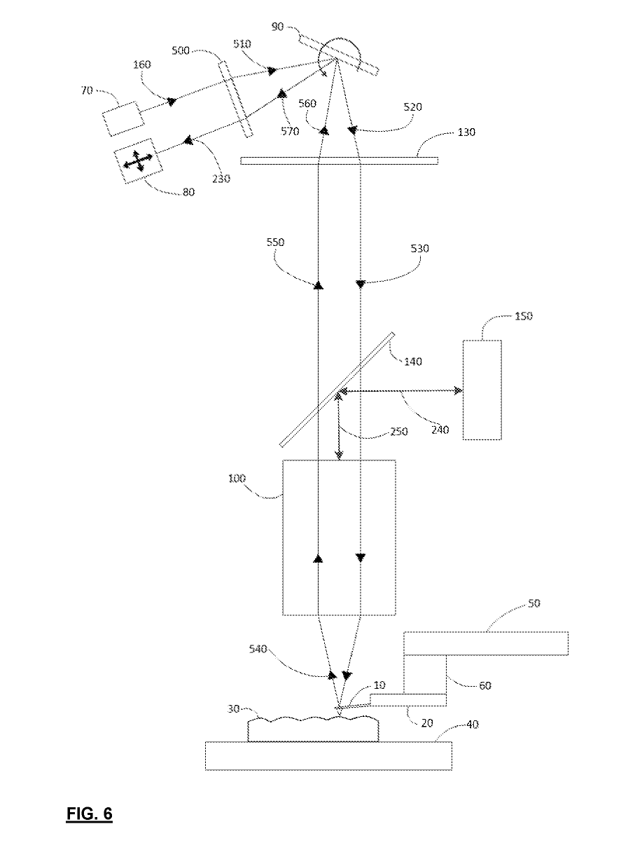

FIG. 6 is a diagram showing a third embodiment where there are two separate telescope lens systems 130 and 500. This configuration is absent the Beam Splitter 110 of the previous embodiments and does not require polarization dependent components, as described in the previous embodiments. However this configuration has other added complications such as off-axis angle coupling particularly as the Beam Steering Device 90 scans in the out-of-plane Y direction. This can occur due to the overall larger average reflecting angle at the Beam Steering Device 90 as compared to the almost normal angles realized in the preferred embodiment shown in FIG. 1 and FIG. 2. The beams reflect from the Beam Steering Device 90 two times, as in the preferred embodiment, however the overall angle of the Beam Steering Device 90 is closer to 45 degrees to the system, therefore this embodiment is referred to as the “45-degree dual-pass” configuration. The Light Source 70 generates a beam 160. A Lens System 500, which is a similar telescope to that of 130, directs and focuses the beam to the Beam Steering Device 90. The beam 520 is reflected from the Beams Steering Device 90 and passes through the Lens System 130 as beam 530. Beam 530 passes through the Top View Beam Splitter 150 and is directed and focused by the Objective 100 onto the Probe 10. The beam reflects from the Probe 10 as beam 540 and is collected by the Objective 100. The beam passes back through the Top View Beam Splitter 140 as beam 550 and passes back through Lens System 130. The Lens System 130 directs and focuses the beam 560 onto the Beam Steering Device 90. The reflected beam 570 is referred to as having been “de-scanned”, due to passing back through the Beam Steering Device 90 a second time. The beam 570 passes through the telescope Lens System 500 as beam 230 and is collected onto the Position Sensitive Detector 80.

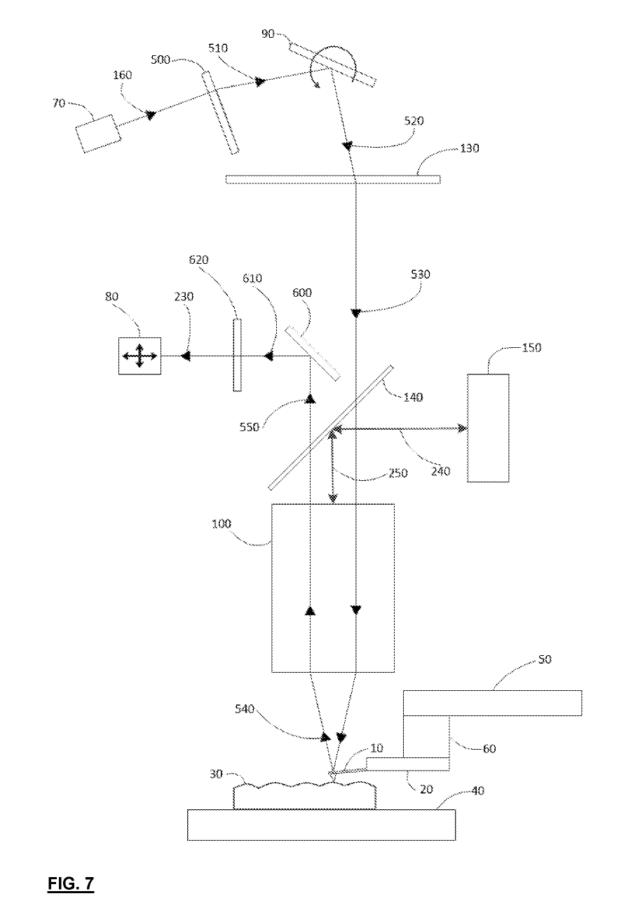

FIG. 7 shows a fourth embodiment of the current invention that is similar to the third embodiment described in FIG. 6. The difference is that the reflected beam 550 is redirected by the Pickoff Mirror 600 before it is collected by the Lens System 130. This embodiment may have some advantages in simplifying the alignment of the return beam, however is not “de-scanned” and has similar disadvantages as to the second embodiment described in FIG. 5 where the adjustment of the Lens 620 and the Position Sensitive Detector 80 is critical for projecting the Back Focal Plane of the Objective 100 onto the Position Sensitive Detector 80.

Because the Beam Steering Device 90 is not physically coupled to the Scanner 50 or 60, it's movement is therefore independent and only coupled to the motion of the Probe 10 through some coordinated means either as open-loop or closed-loop control. In both cases, system identification can be used to calibrate and identify systematic errors that can be applied.

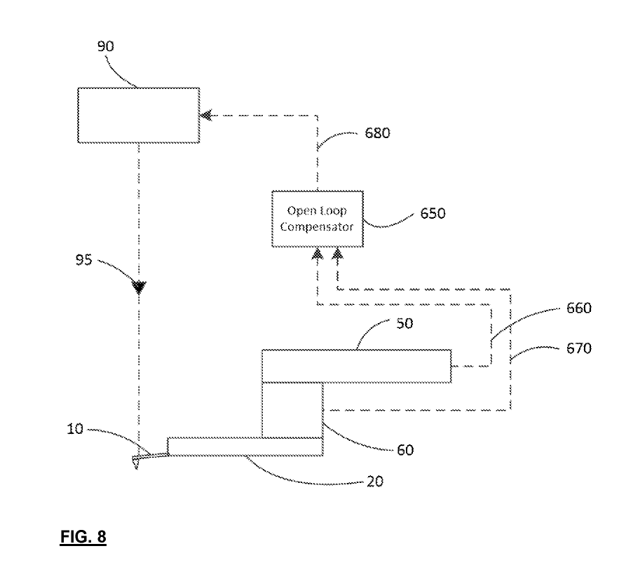

A preferred embodiment for a beam tracking sub-system for use in closed-loop control of the Beam Steering Device 90 is now described. The Open Loop Compensator 650 in FIG. 8 includes system identification information and receives position information from the XY Scanner 50 and the Z Scanner 60 to move the Beam Steering Device 90 from input 680 to steer the beam 95 onto the Probe 10. The position of the XY Scanner 50 and Z Scanner 60 are an approximation of the position of the Probe 10.

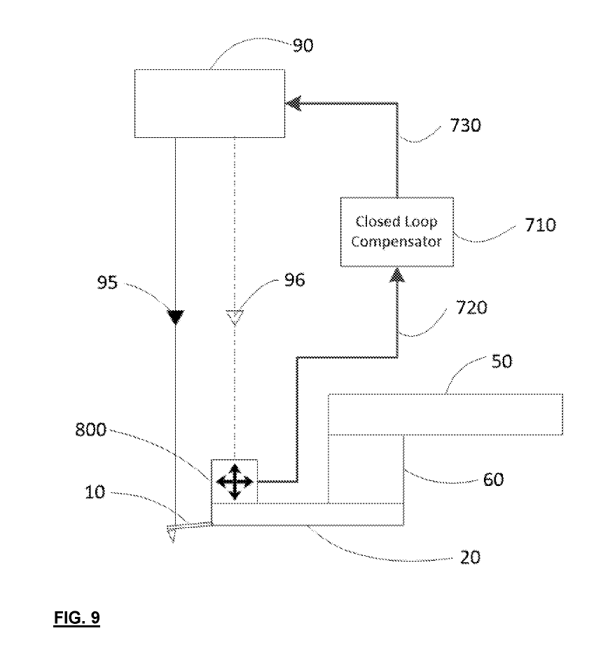

FIG. 9 is a block diagram showing two beams; beam 95, as before, for the AFM Probe Deflection measurement and beam 96 as a second beam for closed loop tracking. Both beams 95 and 96 are moved by the Beam Steering Device 90 simultaneously, therefore they move in coordination with each other. Beam 96 is directed to a Position Sensitive Detector 800 that is located on or near the Probe 10, in this case on the Probe Holder 20. The position output from the Position Sensitive Detector 800 is input as 720 to the Closed Loop Compensator 710. The Closed Loop Compensator 710, which also includes system identification, responds to the input 720 as output 730 to the Beam Steering Device 90 to maintain the beam 96 onto the Position Sensitive Detector 800. The Closed Loop Compensator 710 controls the Beam Steering Device 90 to maintain the beam 96 at a substantially constant location on the Position Sensitive Detector 800. Since beam 95 moves in coordination to beam 96, beam 95 follows the probe.

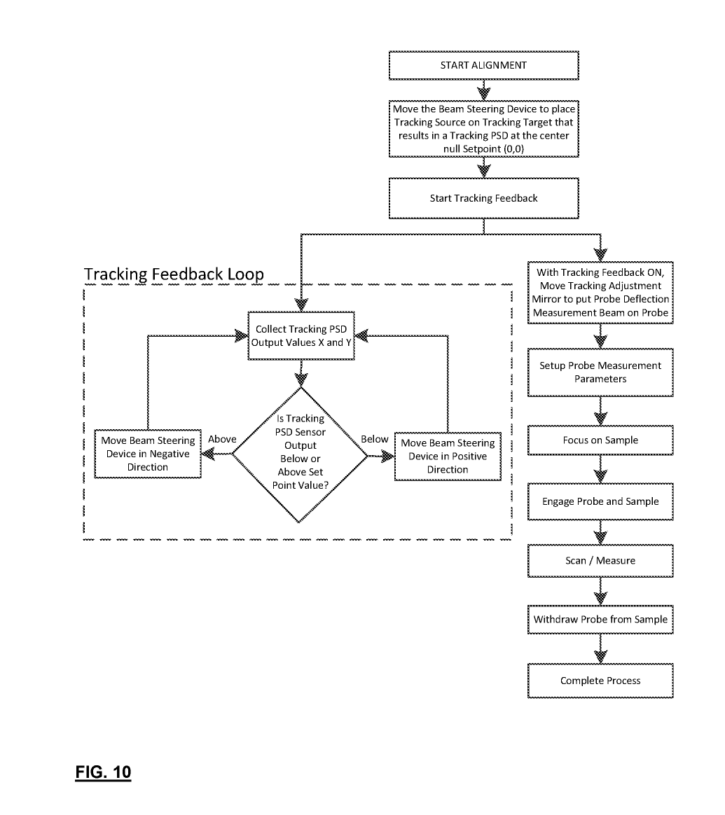

The process of setting up the tracking alignment, turning on the tracking feedback, placing the probe deflection beam onto the probe, and engaging the probe onto the surface is described in FIG. 10. The beam steering device is first used to position the tracking source onto the target which returns the beam onto the tracking detector. At this point the tracking feedback is turned on such that the beam steering device maintains its position such that the tracking feedback detector is kept at its setpoint position, preferably the null or centre location. Now with the tracking feedback on, the beam deflection source can be positioned onto the probe. This is achieved by moving the tracking adjustment stages. In doing so, it is the relative position between the tracking source and the beam deflection source that is being changed at or near the probe. Since the beam deflection device is now in feedback control to keep the tracking source on the target, changes to the tracking source alignment stages will result in movement of the beam deflection source location at the probe. Once both the tracking source is located on the target and the tracking feedback is on and the probe source is located on the probe, the probe parameters can be setup to prepare for engagement and sample measurement. The remainder of the process is typical of most SPM processes in that the sample is then located and engaged followed by scanning measurements then concluding with withdrawal and completion.

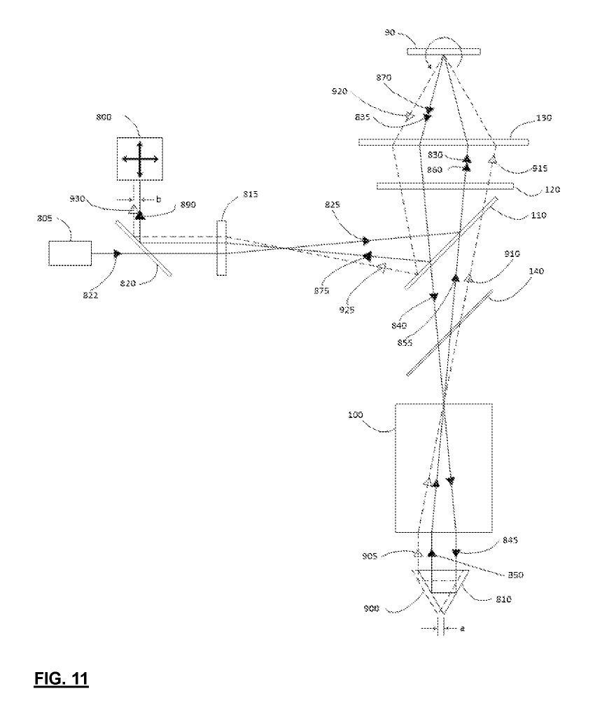

FIG. 11 shows an embodiment of a closed loop beam tracking sub-system. Even though the Position Sensitive Detector 800 can be located on or near the Probe, as described previously in FIG. 9, it is also possible to relocate the Position Sensitive Detector 800 remotely by using a Target 810 on or near the Probe instead. It is preferred to remote the Position Sensitive Detector 800 as there may be harsh environmental conditions near the probe and the Position Sensitive Detector 800 requires electrical connections and can be larger than desired. This target tracking sub-system is integrated into the same optical system already described and used for the AFM probe deflection detection scanning system. The Target 810 in the preferred embodiment is reflective target, in this case a retro-reflector, but could be other reflectors used in the art of beam tracking. FIG. 11 shows how a change in the location of Target 810 to a position at Target 900, of a distance “a” results in an offset of “b” at the Position Sensitive Detector 800 of the beam 890 to 930. Lens 815 is introduced to the target tracking system to project the Front Focal Plane of the Objective 100 onto the Position Sensitive Detector 800. In this way, the Position Sensitive Detector 800 is sensitive to position change of the reflected beam 850 from the Target 810 and not angle as is the case for the Position Sensitive Detector 80 for the probe deflection detection system.

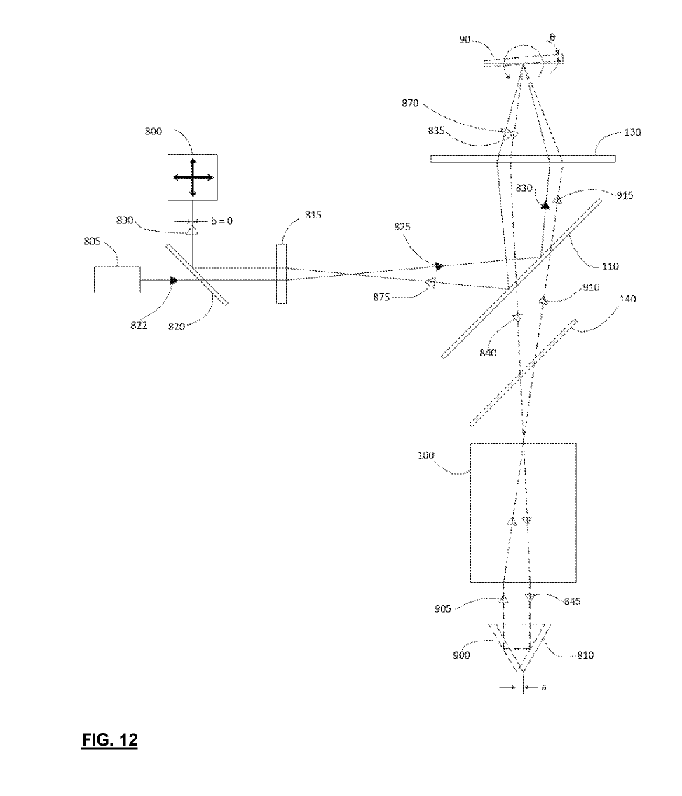

FIG. 12 is a diagram of the result of the Beam Steering Device 90 changing by angle θ in correcting the error “b” to “b=0” at the Position Sensitive Detector 800. This is the result of applying the closed loop compensator described in FIG. 9.

Another embodiment of the present invention for measuring the location of the beam as the probe is moved, for the purposes of a closed loop tracking compensator, is to utilize the Top View camera system to measure the spot location motion as seen through the Objective 100 or to measure its position relative to the probe as it is moved.

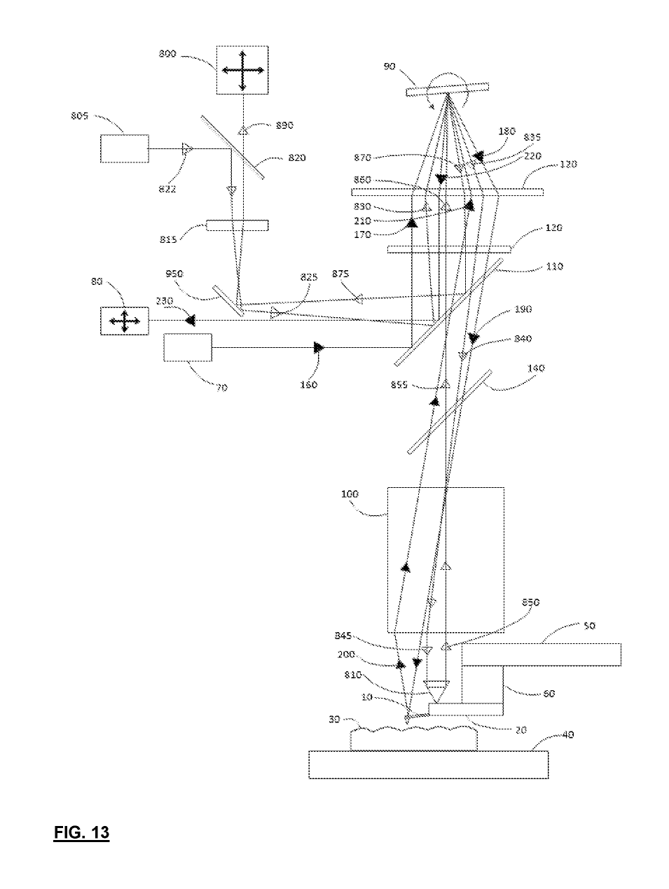

FIG. 13 is the combination of the first embodiment of the configuration for scanning the AFM Deflection Detection System in FIG. 1 and the Laser Tracking System described in FIG. 11 and FIG. 12.

1. A scanning probe microscope, comprising:
a probe configured to move across the surface of a sample to be monitored;
a scanner, to which the probe is mounted, configured to cause said movement of the probe across the sample surface such that the probe is deflected in accordance with the structure of the sample surface;
a beam system for directing a light beam at the probe during said movement of the probe across the sample surface; and
a detector for monitoring the deflection of the probe using the light beam;
wherein the scanner is physically independent of the beam system.

2. A scanning probe microscope according to claim 1, wherein the light beam is directed at the probe by one or more optical elements and wherein none of the optical elements which direct the light beam so as to be incident upon the probe are mounted to the scanner or the probe.

3. A scanning probe microscope according to claim 2, wherein each of the said optical elements is physically mounted to the beam system.

4. A scanning probe microscope according to claim 1, wherein the scanner is moveable independently of the beam system.

5. A scanning probe microscope according to claim 1, further comprising a sample holder for holding the sample and wherein the sample holder is moveable independently of each of the scanner, the probe and the beam system.

6. A scanning probe microscope according to claim 1, wherein the surface of the sample is arranged in use substantially within an X-Y plane and wherein the scanner is configured to move the probe parallel to the X-Y plane.

7. A scanning probe microscope according to claim 1, wherein the beam system is configured to deflect the light beam during the movement of the probe across the sample surface so as to maintain the incidence of the beam upon part of the probe whereby the light beam follows the probe.

8. A scanning probe microscope according to claim 1, wherein the beam system comprises an objective used for directing the said beam onto said probe, wherein the objective has a principal optical axis and wherein beam system is configured such that the angle between the principal optical axis and the part of the light beam between the objective and the probe is substantially independent of the relative position of the probe in a plane normal to the principal optical axis, with respect to the beam system.

9. A scanning probe microscope according to claim 8, wherein the light beam incident upon the probe from the beam system is reflected from the probe and returns to the beam system as a reflected light beam, wherein the relative arrangement between the beam system and the probe is telecentric such that the angle between the part of the reflected light beam that exits the objective and the principal optical axis is dependent upon the movement of the probe in the plane normal to principal optical axis and wherein the position of the part of the reflected light beam that exits the objective with respect to the principal optical axis is dependent upon the angle of the probe in the plane normal to principal optical axis, such that there is a separation of the angular and positional components of the probe in the reflected beam.

10. A scanning probe microscope according to claim 8, wherein the beam system comprises a light source, a first beam separator, a lens system, a beam steering device and a second beam separator and wherein the light source emits the light beam which is directed in a first direction by the first beam separator, through the lens system to the beam steering device, wherein the beam steering device controls the direction of the light beam and directs the light beam back, in a second direction, opposite to the first direction, through the lens system, through the first beam separator and through the second beam separator to the objective, wherein the light passes through the objective in the second direction and is incident upon the probe, wherein the light beam is reflected from the probe back through the objective in the first direction and passes through the second beam separator, through the first beam separator and then the lens system again to the beam steering device, wherein the light beam is again directed by the beam steering device back, in the second direction, through the lens system, to the first beam separator and is directed to the detector.

11. A scanning probe microscope according to claim 1, wherein the beam system comprises a light source, a first beam separator, a lens system, a beam steering device, a second beam separator, an objective and a focusing lens system and wherein the light source emits the light beam which is directed in a first direction by the first beam separator, through the lens system to the beam steering device, wherein the beam steering device controls the direction of the light beam and directs the light beam back, in a second direction, opposite to the first direction, through the lens system, through the first beam separator and through the second beam separator to the objective, wherein the light passes through the objective in the second direction and is incident upon the probe, wherein the light beam is reflected from the probe back through the objective in the first direction and passes through the second beam separator, to the first beam separator and then through the focusing lens system to the detector.

12. A scanning probe microscope according to claim 1, wherein the beam system comprises a light source, a second lens system, a beam steering device, a first lens system, a second beam separator and an objective and wherein the light source emits the light beam which is directed through the second lens system to the beam steering device, wherein the beam steering device controls the direction of the light beam and directs the light beam through the first lens system in a second direction, through the second beam separator to the objective, wherein the light passes through the objective in the second direction and is incident upon the probe, wherein the light beam is reflected from the probe back through the objective in a first direction, opposite to the second direction, and passes through the second beam separator, through the first lens system, to the beam steering device, wherein the beam steering device directs the light beam through the second lens system to the detector.

13. A scanning probe microscope according to claim 1, wherein the beam system comprises a light source, a second lens system, a beam steering device, a first lens system, a second beam separator, an objective, a pick-off mirror and a third lens system and wherein the light source emits the light beam which is directed through the second lens system to the beam steering device, wherein the beam steering device controls the direction of the light beam and directs the light beam through the first lens system in a second direction, through the second beam separator to the objective, wherein the light passes through the objective in the second direction and is incident upon the probe, wherein the light beam is reflected from the probe back through the objective in a first direction, opposite to the second direction, and passes through the second beam separator, is reflected off the pick-off mirror and passes through the third lens system to the detector.

14. A scanning probe microscope according to claim 11, wherein the objective and second beam separator are arranged to provide a top view image of the sample.

15. A scanning probe microscope according to claim 11, wherein one or more of the first or second beam separators is selected from the group comprising: a polarizing beam splitter and quarter wave plate, a non-polarizing beam splitter, an optical filter or spatially separated mirrors.

16. A scanning probe microscope according to claim 11, wherein the beam steering device is selected from the group comprising: a Micro Electro Mechanical System mirror device, a goniometer or an acousto-optic modulator.

17. A scanning probe microscope according to claim 1, wherein the detector is a position sensitive detector.

18. A scanning probe microscope according to claim 11, wherein the beam system is configured to project the back focal plane of the objective on to the detector.

19. A scanning probe microscope according to claim 1, further comprising a control system configured to receive position signals relating to the position of the probe and provide control signals to the beam system in response to the position signals in order to direct the light beam on to the probe.

20. A scanning probe microscope according to claim 19, wherein the position signals are provided by the scanner.

21. A scanning probe microscope according to claim 19, wherein the beam system further comprises a tracking system in which a tracking light beam is used to track the movement of the probe using a position sensitive detector and wherein the control system monitors the movement of the tracking light beam using the position sensitive detector and provides corresponding control signals to the beam system so as to deflect the light beam to track the probe.

22. A scanning probe microscope according to claim 21, wherein the position sensitive detector is mounted to the probe or the scanner.

23. A scanning probe microscope according to claim 21, wherein the position sensitive detector is remote from the scanner and probe and the tracking light beam follows a path through the beam system which is generally parallel to that of the light beam used for monitoring the deflection of the probe.

24. A scanning probe microscope according to claim 23, and when dependent upon claim 10, wherein the tracking system comprises a tracking light source, a tracking beam separator and a tracking lens system and wherein the tracking light source emits the tracking light beam which is incident upon the tracking beam separator and then the tracking lens and then enters the beam system via the first beam separator, travels to and from the probe using the beam system, is received from the first beam separator, passes through the tracking lens system and tracking beam separator and is received at the position sensitive detector.

25. A scanning probe microscope according to claim 21, wherein a reflective target is mounted on or near the scanned probe to reflect the tracking light beam.

26. A scanning probe microscope according to claim 20, wherein the control system is configured to monitor the position of the probe at a rate sufficient to correct the beam steering device to follow said probe when being moved by said scanner.
